(19) United States
(12) Patent Application Publication
(10) Pub. No.: US 2013/0155285 A1
(43) Pub. Date: Jun. 20, 2013

(54) Interactive Electronic Device

(71) Applicant: PixArt Imaging Inc., Hsinchu City (TW)

(72) Inventor: Shu-Sian YANG, HSINCHU City (TW)

(73) Assignee: PIXART IMAGING INC., HSINCHU City (TW)

(21) Appl. No.: 13/715,985

(22) Filed: Dec. 14, 2012

(30) Foreign Application Priority Data
Dec. 16, 2011 (TW) 100146931

(51) Int. Cl. H04N 5/232

(52) U.S. Cl. CPC H04N 5/232
USPC 348/231.99; 348/222.1

(57) ABSTRACT

An interactive electronic device includes an image capture module, a response module and a processing module. The image capture module is configured to capture an image. The response module is configured to output a control signal according to a pattern contained in the image. The processing module is electrically connected to the image capture module and the response module and configured to drive the interactive electronic device according to the control signal.

### TECHNICAL FIELD

The present invention relates to an interactive electronic device, and more particularly to an interactive electronic device capable of performing various interactive modes in response to a specific pattern(s) on an image being identified.

### BACKGROUND

Toys always are extremely important entertainment products in human life. In recent years, with the advances in electronic technology, videos game technologies are also integrated into the toy designs and thereby causing, due to the modern science elements in the modern toys, some conventional toys have been gradually disappeared.

With the popularity of electronic games, players may not have the best playing experiences if the toy cannot interact with the players; in other words, the interaction relationship between a player and a toy has become a key element to enhance the entertainment.

Therefore, it is desirable to provide an interactive electronic device capable of providing a variety of interactive modes with children or even adults so as to increase the entertainment.

### SUMMARY OF EMBODIMENTS

Therefore, one object of the present invention is to provide an interactive electronic device capable of performing various response actions according to a specific pattern contained in a captured image of an object.

The present invention provides an interactive electronic device, which includes an image capture module, a response module and a processing module. The image capture module is configured to capture an image. The response module is configured to output a control signal according to a pattern contained in the image. The processing module is electrically connected to the image capture module and the response module and configured to drive the interactive electronic device according to the control signal.

In an embodiment of the present invention, the interactive electronic device further includes at least an accessory. The image capture module is configured to capture an image of each accessory; each accessory includes at least a pattern thereon functioning as a representative of the associated accessory.

In an embodiment of the present invention, the image capture module is configured to identify the pattern contained in the image and accordingly generate identification data. The processing module is configured to output the control signal according to the identification data. The image capture module includes a storage unit, an image capture unit and a processing unit. The storage unit is configured to store with a plurality of characteristic data. The image capture unit is configured to capture the image. The processing unit is electrically connected to the storage unit and the image capture unit and configured to identify at least a characteristic of the image, compare the characteristic(s) with the characteristic data and accordingly generate the identification data.

In an embodiment of the present invention, the processing module is configured to identify the image(s) captured by the image capture module, accordingly generate identification data, and output the control signal according to the identification data. The processing module includes a storage unit and a processing unit electrically connected to the storage unit. The storage unit is configured to store with a plurality of characteristic data. The processing unit is configured to identify at least a characteristic of the image, compare the characteristic(s) with the characteristic data and accordingly generate the identification data.

In an embodiment of the present invention, the image capture module includes an image capture unit and a first processing unit electrically connected to the image capture unit. The image capture unit is configured to capture the image. The first processing unit is configured to search at least a characteristic from the image and transmit the characteristic(s) to the processing module. The processing module includes a storage unit and a second processing unit electrically connected to the storage unit. The storage unit is configured to store with a plurality of characteristic data. The second processing unit is configured to compare the characteristic(s) with the characteristic data so as to determine a type of the specific pattern and control the response module to perform a corresponding response action.

In an embodiment of the present invention, the specific pattern is a barcode or a texture.

In an embodiment of the present invention, the interactive electronic device further includes a main body. The main body is an electronic doll. The response module is disposed in a head and/or limbs of the electronic doll.

In an embodiment of the present invention, the interactive electronic device further includes at least an accessory. The image capture module is configured to capture an image of the accessory. The accessory includes at least a specific pattern thereon functioning as a representative of the accessory. The accessory has a ball-like shape, a bone-like shape or a milk-bottle-like shape.

In an embodiment of the present invention, the image captured by the image capture module is associated with a detection result. The detection result includes a relative position information and a relative position information between the specific pattern and the main body.

In summary, due to the processing module can output a control signal according to a specific pattern contained in the image captured by the image capture module and the response module can drive the interactive electronic device according to the control signal, the interactive electronic device of the present invention can perform various response actions in response to objects with various patterns are detected; and thus, the mean for interacting with various objects is realized in the present invention.

### BRIEF DESCRIPTION OF THE DRAWINGS

The above embodiments will become more readily apparent to those ordinarily skilled in the art after reviewing the following detailed description and accompanying drawings, in which:

FIG. 1A is a schematic block view of an interactive electronic device in accordance with a first embodiment of the present invention;

FIG. 1B is a schematic view illustrating an electronic doll, realized by the interactive electronic device, and a number of objects which are configured to interact with the electronic doll;

FIG. 2 is a schematic block view of the image capture module in FIG. 1A;

FIGS. 3A, 3B are schematic views illustrating a process of the electronic doll shown in FIG. 1B interacting with an object;

FIG. 4 is a schematic block view of an interactive electronic device in accordance with a second embodiment of the present invention;

FIG. 5 is a schematic block view of a processing module in FIG. 4;

FIG. 6 is a schematic block view of an interactive electronic device in accordance with a third embodiment of the present invention;

FIG. 7A is a schematic block view of an image capture module in FIG. 6; and

FIG. 7B is a schematic block view of a processing module in FIG. 6.

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

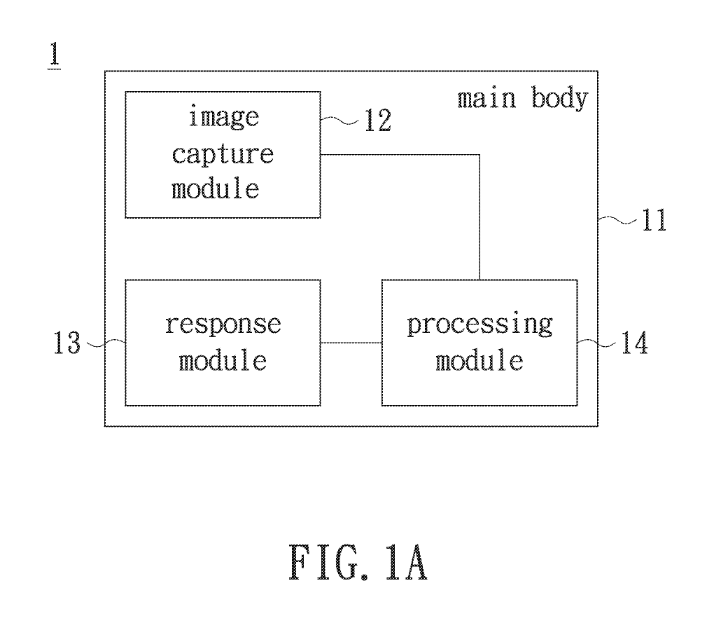

FIG. 1A is a schematic block view of an interactive electronic device in accordance with a first embodiment of the present invention. As shown, the interactive electronic device 1 of the present embodiment is configured to perform various response actions in response various objects (not shown) with a specific pattern are detected, so as to realized a function capable of interacting with a plurality of various objects. The interactive electronic device 1 includes an image capture module 12, a response module 13 and a processing module 14; wherein the processing module 14 is electrically connected to the image capture module 12 and the response module 13. In addition, the interactive electronic device 1 may further include a main body 11, in which the image capture module 12, the response module 13 and the processing module 14 are disposed.

Hereafter the main body 11 of the interactive electronic device 1 is exemplified by an electronic doll; however, it is understood that the present invention does not limit the appearance of the main body 11. Moreover, hereafter the main body 11 having the image capture module 12, the response module 13 and the processing module 14 disposed in is also referred to an electronic doll 15.

FIG. 1B is a schematic view illustrating an electronic doll, realized by the interactive electronic device 1, and a number of objects which are configured to interact with the electronic doll. Please refer to FIGS. 1A, 1B. The main body 11 of the electronic doll 15 has, for example but without a limitation, a dog appearance. The image capture module 12 and the response module 13 are disposed in the main body 11; wherein the lens of the image capture module 12 is configured to serve an eye(s) of the electronic doll 15, and the response module 13 can be disposed in the movable parts (for example, a head and/or limbs) of the main body 11.

The image capture module 12 is configured to capture images of a number of various objects. The processing module 14 is configured to output a control signal according to a specific pattern contained in the captured images; in other words, the control signal is associated with the specific pattern contained in the captured image. The response module 13 is configured to drive the interactive electronic device 1 according to the control signal; in other words, the control signal is configured to control the response module 13 to perform a specific response action (for example, control the response module 13 to have a running action) and thereby further driving the electronic doll 15. Thus, the interactive electronic device 1 according to the present embodiment can perform specific response actions when various corresponding objects are detected.

The aforementioned specific pattern can be the overall outline of the appearance of an object; and the object is, for example, a ball (designated by Q1), a milk bottle (designated by Q2) or a bone (designated by Q3). Thus, the interactive electronic device 1 can perform a specific response action when one of the objects Q1, Q2 and Q3 is detected. Or, in another embodiment, the interactive electronic device 1 is configured to perform a specific response action only when a corresponding accessory (for example, the accessories M1, M2 or M3) is detected; wherein the accessories M1, M2 and M3 are designed to be associated with the interactive electronic device 1, and each has a specific corresponding pattern thereon functioning as a representative of the associated accessory. For example, the accessory M1 has a ball-like shape and the pattern P1 thereon is, for example, a circle; and thus, the interactive electronic device 1 can determine that the accessory M1 has a ball-like shape when the pattern P1 (or a circle) is detected. Similarly, the accessory M2 has a milk-bottle-like shape and the pattern P2 thereon is, for example, a square; and thus, the interactive electronic device 1 can determine that the accessory M2 has a milk-bottle-like shape when the pattern P2 (or a square) is detected. Similarly, the accessory M3 has a bone-like shape and the pattern P3 thereon has, for example, an X-like mark; and thus, the interactive electronic device 1 can determine that the accessory M3 has a bone-like shape when the pattern P3 (or an X-like mark) is detected. It is understood that the pattern on the associated accessory in other embodiments is, for example, a barcode or a specific texture; in other words, as long as the pattern is recognizable to the interactive electronic device 1, the present invention does not limit the types of the pattern.

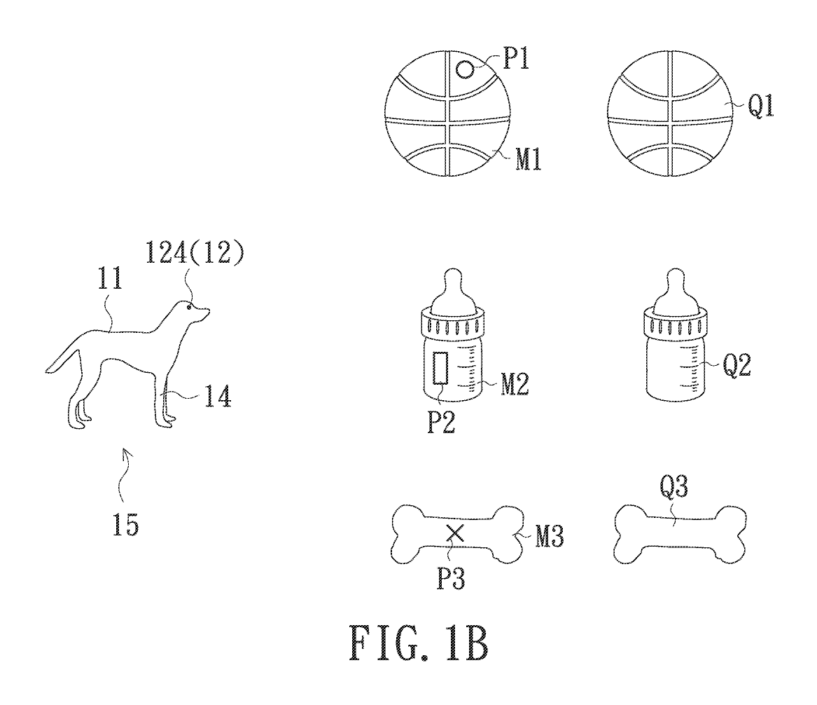

When a player, through an object or an accessory, is interacting with the electronic doll 15, firstly the first electronic dolls 15 performs an identification process on the object or the accessory. FIG. 2 is a schematic block view of the image capture module 12, configured to perform the identification process on an object or an accessory, in accordance with the first embodiment of the present invention. As shown, the image capture module 12 includes a storage unit 121, an image capture unit 122 and a processing unit 123; wherein the processing unit 123 is electrically connected to the storage unit 121 and the image capture unit 122.

### Identification Process in the First Embodiment

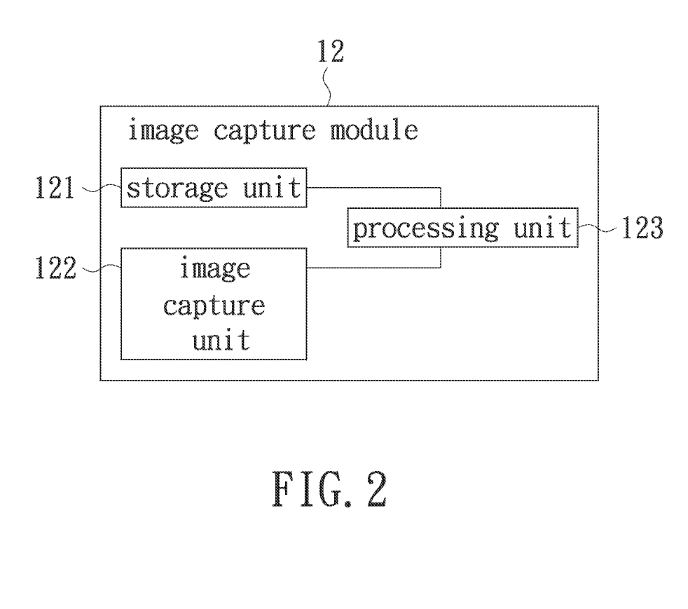

Please refer to FIGS. 2, 3A. The electronic doll 15 is, for example, in a still state before a player interacts with it. The image capture unit 122 of the electronic doll 15 is configured to have a determined detection region; wherein the detection region is designated by the dotted lines as shown in FIG. 3A, and the detection region has, for example but without a limitation, a range of 10 meters.

Please refer to FIGS. 2, 3B. Then, the image capture unit 122 is configured to capture an image of the object Q1 when the object Q1 is thrown within the detection region of the image capture unit 122 by the player; wherein a detection result, for indicating a relative position information and a relative distance information between the object Q1 and the main body 11, can be derived from this captured image. Next, the image capture unit 122 is configured to transmit the captured image to the processing unit 123 for the identification process. The processing unit 123 is configured to search at least one characteristic contained in the image; wherein the characteristic(s) is, for example, a shape characteristic, a size characteristic or a color characteristic, or, a combination of them. In addition, the characteristic search may be realized by a global characteristic search or a local characteristic search; wherein the local characteristic search is associated with the local binary pattern (LBP) or the Haar pattern, and the global characteristic search is associated with the color histogram pattern.

Afterwards, the processing unit 123 is configured to compare at least one characteristic contained in the captured image of the object Q1 with the characteristic data stored in the storage unit 121 so as to generate identification data; wherein the comparison is realized, for example but without a limitation, by vector inner product.

Accordingly, once the identification data is generated, the processing unit 123 can determine that the object thrown within the detection region of the image capture unit 122 is the object Q1 with a ball-like shape, and also the relative distance information and the relative position information between the object Q1 and the electrons doll 15 are determined. Then, the processing unit 123 is configured to transmit the identification data associated with the object Q1 to the processing module 14. The processing module 14 is configured to generate a control signal according to the identification data and transmit the control signal to the response module 13. Consequently, the response module 13 is configured to control the electrons doll 15 to perform a specific response action according to the control signal. For example, the control signal may be configured to drive the four limbs to have a running action so as to drive the electronics doll 15 to chase the ball-like object Q1. Once the electronic doll 15 touches the ball-like object Q1, the control signal may further drive the response module 13 to perform another specific response action to the object Q1, such as driving the four limbs of the electronic doll 15 to play with the ball.

Therefore, based on the aforementioned description the interaction between the interactive electronic device 1 and an object is realized. In addition, although the interactive electronic device 1 in the aforementioned description is exemplified by having specific response actions (for example, run, chase and play) with the ball-like object Q1, it is to be noted that the interactive electronic device 1 of the present invention does not limit the interacting object as well as the associated response actions; in other words, the interactive electronic device 1 according to the present embodiment can be configured to perform various response actions according to various types of object.

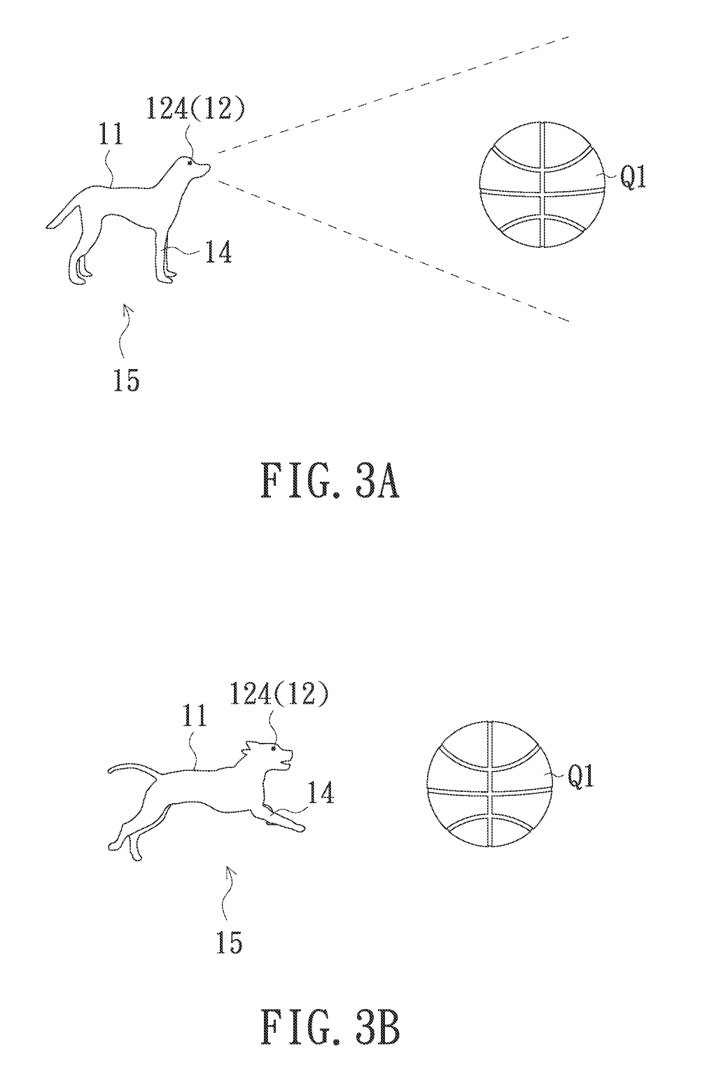

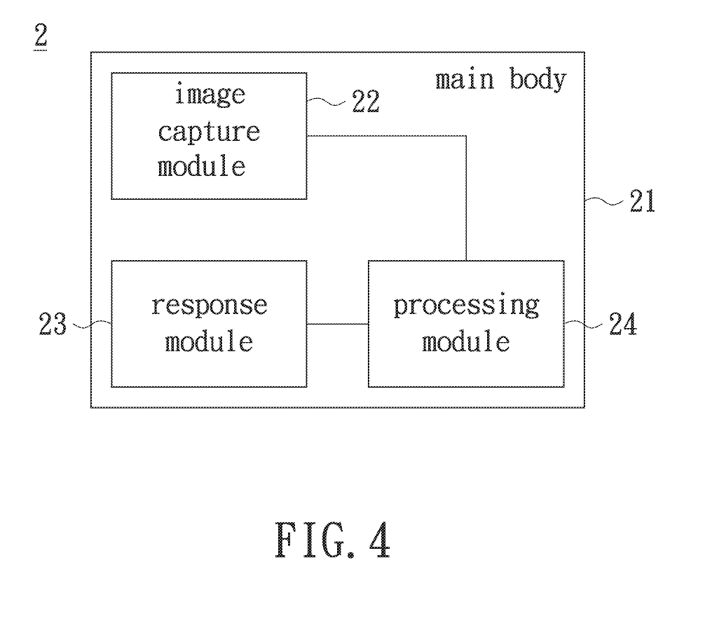

FIG. 4 is a schematic block view of an interactive electronic device in accordance with a second embodiment of the present invention. FIG. 5 is a schematic block view of a processing module in FIG. 4. As shown, the interactive electronic device 2 includes an image capture module 22, a response module 23 and a processing module 24; wherein the processing module 24 is electrically connected to the image capture module 22 and the response module 23. In addition, the interactive electronic device 2 may further include a main body 21, in which the image capture module 22, the response module 23 and the processing module 24 are disposed. The interactive electronic device 2 according to the present embodiment is similar to the interactive electronic device 1 shown in FIG. 1A, and the main difference between the two is that the image identification is realized by the processing module 24.

The main body 21 and the response module 23 in the present embodiment each have functions similar to that of the main body 11 and the response module 13 of the first embodiment, respectively; and thus, no any unnecessary detail will be given here. In particular, the image capture module 22 is configured to capture images of an object (not shown) and transmit the captured images to the processing module 24. The processing module 24 is configured to identify the captured images, generate identification data according to the captured images, and output a control signal according to the identification data. Specifically, the processing module 24 includes a storage unit 241 and a processing unit 242; wherein the processing unit 242 is electrically connected to the storage unit 241. The storage unit 241 is configured to store with a plurality of characteristic data. The processing unit 242 is configured to identify at least one characteristic of the captured image, compare the characteristic(s) with the stored characteristic data so as to generate identification data, and output a control signal corresponding to the identification data to the response module 23. The response module 23 is configured to be driven by the control signal to perform a specific response action. The process of identifying images and the means of generating the identification data are similar to that of the first embodiment; and thus, no any unnecessary detail will be given here.

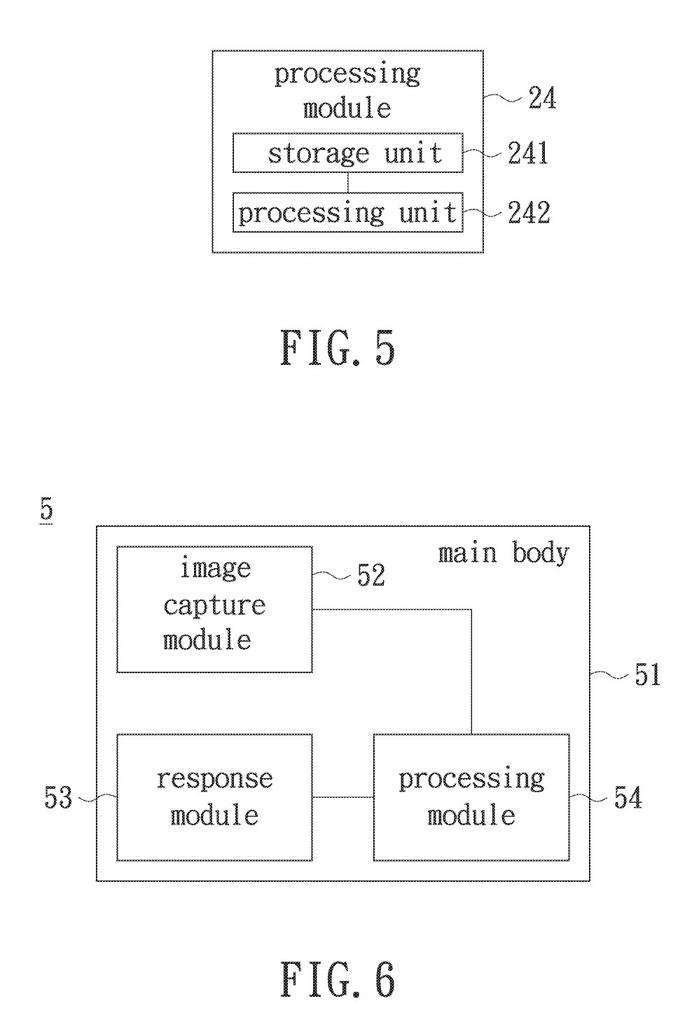

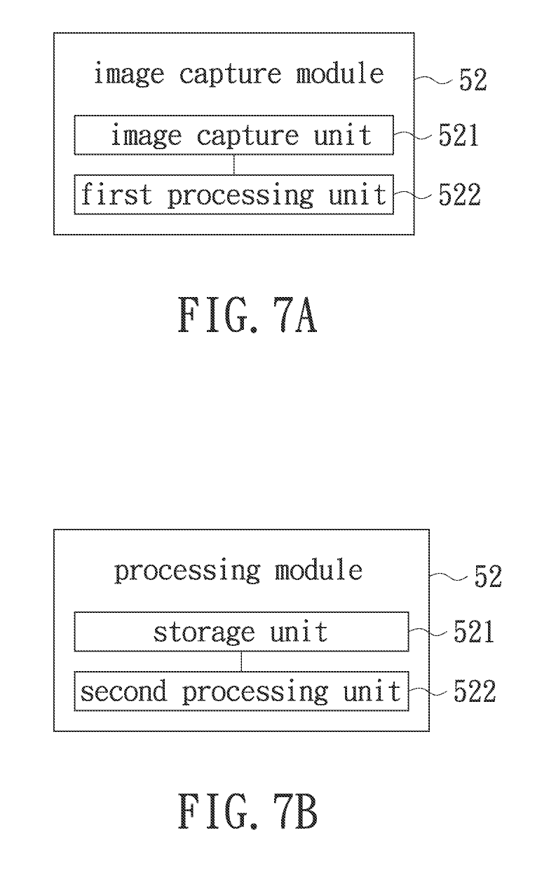

FIG. 6 is a schematic block view of an interactive electronic device in accordance with a third embodiment of the present invention. FIG. 7A is a schematic block view of an image capture module in FIG. 6. FIG. 7B is a schematic block view of a processing module in FIG. 6. As shown, the interactive electronic device 5 includes an image capture module 52, a response module 53 and a processing module 54; wherein the processing module 54 is electrically connected to the image capture module 52 and the response module 53. In addition, the interactive electronic device 5 may further include a main body 51, in which the image capture module 52, the response module 53 and the processing module 54 are disposed. The interactive electronic device 5 according to the present embodiment is similar to the interactive electronic device 1 shown in FIG. 1A, and the main difference between the two is that the image identification is realized by the image capture module 52 and the processing module 54.

The main body 51 and the response module 53 in the present embodiment each have functions similar to that of the main body 11 and the response module 13 of the first embodiment, respectively; and thus no any unnecessary detail will be given here. Moreover, the image capture module 52 includes an image capture unit 521 and a first processing unit 522; wherein the first processing unit 522 is electrically connected to the image capture unit 521. In particular, the image capture unit 521 is configured to capture images of an object (not shown) and transmit the captured images to the first processing unit 522. The first processing unit 522 is configured to search at least one characteristic from the captured image and transmit the characteristic(s) to the processing module 54; wherein the characteristic(s) in the captured image and the means for searching the characteristic(s) from the captured image are similar to that in the first embodiment, and thus, no any unnecessary detail will be given here. In addition, the processing module 54 includes a storage unit 541 and a second processing unit 542; wherein the second processing unit 542 is electrically connected to the storage unit 541. The storage unit 541 is configured to store with a plurality of characteristic data. The second processing unit 542 is configured to compare the characteristic(s) of the captured image with the characteristic data so as to determine the type of a specific pattern contained in the captured image, and accordingly control the response module 53 to perform a specific response action. The characteristic comparison means are similar to that in the first embodiment; and thus, no any unnecessary detail will be given here.

In summary, due to the processing module can output a control signal according to a specific pattern contained in the image captured by the image capture module and the response module can drive the interactive electronic device according to the control signal, the interactive electronic device of the present invention can perform various response actions in response to objects with various patterns are detected; and thus, the mean for interacting with various objects is realized in the present invention. Moreover, in one embodiment, because the interactive electronic device includes specific accessories each including a specific easy-to-identify pattern thereon, the interactive electronic device can, without a complicated image identification process, perform a response action in response to a specific accessory is detected. In addition, because the image identification process is relatively simpler and can be realized by a low-level processor, the interactive electronic device disclosed in the present invention not only can have a higher response speed, but also can have a lower production cost when a low-level processor is adopted therein.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An interactive electronic device, comprising:
an image capture module configured to capture an image;
a response module configured to output a control signal according to a pattern contained in the image; and
a processing module electrically connected to the image capture module and the response module and configured to drive the interactive electronic device according to the control signal.

2. The interactive electronic device according to claim 1, further comprising at least an accessory, wherein the image capture module is configured to capture an image of each accessory, each accessory comprises at least a pattern thereon functioning as a representative of the associated accessory.

3. The interactive electronic device according to claim 1, wherein the image capture module is configured to identify the pattern contained in the image and accordingly generate identification data, the processing module is configured to output the control signal according to the identification data.

4. The interactive electronic device according to claim 3, wherein the image capture module comprises:
a storage unit configured to store with a plurality of characteristic data;
an image capture unit configured to capture the image; and
a processing unit electrically connected to the storage unit and the image capture unit and configured to identify at least a characteristic of the image, compare the characteristic(s) with the characteristic data and accordingly generate the identification data.

5. The interactive electronic device according to claim 4, wherein the characteristic(s) is selected from a group consisting of a shape characteristic, a size characteristic and a color characteristic.

6. The interactive electronic device according to claim 1, wherein the processing module is configured to identify the image(s) captured by the image capture module, accordingly generate identification data, and output the control signal according to the identification data.

7. The interactive electronic device according to claim 6, wherein the processing module comprises a storage unit and a processing unit electrically connected to the storage unit, the storage unit is configured to store with a plurality of characteristic data, the processing unit is configured to identify at least a characteristic of the image, compare the characteristic(s) with the characteristic data and accordingly generate the identification data.

8. The interactive electronic device according to claim 7, wherein the characteristic(s) is selected from a group consisting of a shape characteristic, a size characteristic and a color characteristic.

9. The interactive electronic device according to claim 1, wherein the image capture module comprises an image capture unit and a first processing unit electrically connected to the image capture unit, the image capture unit is configured to capture the image, the first processing unit is configured to search at least a characteristic from the image and transmit the characteristic(s) to the processing module, the processing module comprises a storage unit and a second processing unit electrically connected to the storage unit, the storage unit is configured to store with a plurality of characteristic data, the second processing unit is configured to compare the characteristic(s) with the characteristic data so as to determine a type of the specific pattern and control the response module to perform a corresponding response action.

10. The interactive electronic device according to claim 9, wherein the characteristic(s) is selected from a group consisting of a shape characteristic, a size characteristic and a color characteristic.

11. The interactive electronic device according to claim 1, wherein the specific pattern is a barcode or a texture.

12. The interactive electronic device according to claim 1, further comprising a main body, wherein the main body is an electronic doll, the response module is disposed in a head and/or limbs of the electronic doll.

13. The interactive electronic device according to claim 12, further comprising at least an accessory, the image capture module is configured to capture an image of the accessory, the accessory comprises at least a specific pattern thereon functioning as a representative of the accessory, the accessory has a ball-like shape, a bone-like shape or a milk-bottle-like shape.

14. The interactive electronic device according to claim 1, wherein the image captured by the image capture module is associated with a detection result, the detection result includes a relative position information and a relative position information between the specific pattern and the main body.
